(19) United States
(12) Patent Application Publication
(10) Pub. No.: US 2023/0177408 A1
(43) Pub. Date: Jun. 8, 2023

(54) TRAINING MACHINE LEARNING MODELS TO PREDICT FIRE BEHAVIOR

(71) Applicant: X Development LLC, Mountain View, CA (US)

(72) Inventors: Akshina Gupta, Warren, NJ (US); Eliot Julien Cowan, Atherton, CA (US)

(21) Appl. No.: 18/075,723

(22) Filed: Dec. 6, 2022

Related U.S. Application Data
(60) Provisional application No. 63/265,038, filed on Dec. 7, 2021.

(51) Int. Cl. G06N 20/20

(52) U.S. Cl. CPC G06N 20/20

(57) ABSTRACT

Methods, systems, and apparatus for obtaining a first plurality of data elements, each data element representing a fire-related metric of a geographic region, determining, using at least a subset of the first data elements, one or more values representing one or more derived fire-related metrics, associating the one or more values with the first data elements, obtaining a second plurality of data elements, each data element representing a fire-related metric of the geographic region, and training a machine learning (ML) model using at least a subset of the first plurality of data elements, at least a subset of the second plurality of data elements, and values associated with the subset of the first plurality of data elements to provide a trained ML model.

This application claims the benefit of and priority to U.S. Prov. App. No. 63/265,038 filed on Dec. 7, 2021, which is expressly incorporated herein by reference for all purposes.

### TECHNICAL FIELD

This specification relates to machine learning, and more particularly to training a machine learning model to predict fire behaviors.

### BACKGROUND

Natural disasters are increasing in both frequency and intensity. Example natural disasters can include wildfires, hurricanes, tornados, and floods, among several others. Natural disasters often result in significant loss that can include a spectrum of economic losses, property losses, and physical losses (e.g., deaths, injuries). Consequently, significant time and effort is expended not only predicting occurrences of natural disasters, but characteristics of natural disasters such as duration, severity, spread, and the like. Technologies, such as machine learning (ML), have been leveraged to generate predictions around natural disasters. However, natural disasters present a special use case for predictions using ML models, which results in technical problems that must be addressed to generate reliable and actionable predictions.

### SUMMARY

In general, innovative aspects of the subject matter described in this specification relate to training a machine learning (ML) model to predict fire behavior. More particularly, innovative aspects of the subject matter described in this specification relate to determining at least one metric related to fires and using the metric to train a ML model to predict fire behavior. For example, implementations of the present disclosure enable a likelihood of occurrence of a fire to be predicted in advance (e.g., seasons or years ahead) absent specific fire events that can be simulated for respective geographic regions.

In general, innovative aspects of the subject matter described in this specification can include actions of obtaining a first plurality of data elements, each data element representing a fire-related metric of a geographic region, determining, using at least a subset of the first data elements, one or more values representing one or more derived fire-related metrics, associating the one or more values with the first plurality of data elements, obtaining a second plurality of data elements, each data element representing a fire-related metric of the geographic region, and training a ML model using at least a subset of the first plurality of data elements, at least a subset of the second plurality of data elements, and the values associated with the subset of the first plurality of data elements to provide a trained ML model. Other implementations of this aspect include corresponding systems, apparatus, and computer programs, configured to perform the actions of the methods, encoded on computer storage devices.

These and other implementations can each optionally include one or more of the following features: actions further include generating an input from at least the subset of the first plurality data elements, at least the subset of the second plurality of data elements and the one or more values, and processing the input using the trained ML model that is configured to generate a fire risk prediction output that characterizes predicted future behaviors of a fire; the geographic region is contiguous; at least one fire-related metric is related to one of terrain and weather; the derived fire-related metrics include one or more of speed, size, duration, and expansion; and the ML model includes one of a gradient boosted decision tree, a random forest, and a convolutional neural network.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

Particular implementations of the subject matter described in this specification can be executed so as to realize one or more of the following advantages. The techniques described below can be used to produce a combination of features that can be used to more robustly train a ML model to predict fire behavior. In some examples, the combination of features includes a metric representing a fire-related behavior. The value of the derived fire-related metric can be associated with all regions of a zone burned during a fire. Among other advantages, associating the same value with all regions during training improves training—that is, model trained using the techniques described in this specification result in more accurate predictions. Further, implementations of the present disclosure enable prediction of fire characteristics (e.g., likelihood of occurrence) in geographic regions that have historically not experienced fire events. Implementations of the present disclosure also enable fire characteristics to be predicted relatively far in advance as compared to traditional simulation techniques. For example, probable behavior of a fire that hits a specific region can be predicted over a year ahead of the occurrence of a fire.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for training one or more fire behavior machine learning (ML) models.

FIG. 2 is a flow diagram of an example process for training one or more fire behavior ML models.

FIGS. 3A-3C are illustrations of example fire property predictions.

FIG. 4 is a diagram of an example system for predicting fire severity.

FIG. 5 is a flow diagram of an example process for predicting fire severity.

Like reference numbers and designations in the various drawings indicate like elements.

### DETAILED DESCRIPTION

This specification describes systems, methods, devices, and other techniques relating to training a machine learning (ML) model to predict fire behavior. More particularly, innovative aspects of the subject matter described in this specification relate to determining at least one metric related to fires and using the metric to train a ML model to predict fire behavior. For example, implementations of the present disclosure enable a likelihood of occurrence of a fire to be predicted in advance (e.g., seasons or years ahead) absent specific fire events that can be simulated for respective geographic regions.

Implementations of the present disclosure are described in further detail herein with reference to an example natural disaster, which includes wildfires. It is contemplated, however, that implementations of the present disclosure are applicable to any appropriate natural disaster. For example, implementations of the present disclosure can be used to determine potential impact of mitigation actions that are appropriate to a respective natural disaster.

To provide context for the subject matter of the present disclosure, and as introduced above, ML has been leveraged to generate predictions around natural disasters. For example, ML models can be used to generate predictions representative of characteristics of a natural disaster, such as likelihood of occurrence, duration, severity, spread, among other characteristics, of the natural disaster.

Traditionally, fire-likelihood and fire-hazard maps have shown areas where fires are likely to occur. However, while it is important to determine where fire risk exists, behaviors of a fire that burns an area are also important in determining fire impact. For example, if an area is burned by a fast fire, damage might be less extensive than an area burned by a slow fire. In another example, fires that cover larger areas can be more difficult to suppress than fires that cover smaller areas.

For these reasons, among others, there is a need to predict behavior(s) of a fire. Example behaviors of a fire can include, without limitation, speed and size. Such behaviors can be used, for example, to determine appropriate fire suppression actions in the case a fire ignites in an area and the magnitude of a risk should a fire ignite. However, to predict the behavior of a fire, a ML model must be trained using training examples that include labels relating to the behaviors of the fire. Such behaviors, however, are typically not included in training data. Therefore, the data available to train a fire behavior ML model is often not sufficiently robust to produce effective training. That is, there is a data sparsity issue in training of ML models that predict fire behaviors.

In view of this, the techniques in this specification address data sparsity issues by using a combination of features, including derived features, to more robustly train a ML model to predict behavior of a natural disaster, such as a wildfire. The techniques described in his specification can generate derived features that are not present in the initial training data and use those derived features as supplemental training data to train a fire-behavior ML model.

In further detail, one or more ML models can be trained to predict characteristics of a natural disaster using training data that is representative of characteristics of occurrences of the natural disaster, for example. Example types of ML models can include Convolutional Neural Networks (CNNs), Residual Neural Networks (RNNs), Generative Adversarial Networks (GANs). The training data can include region data representative of respective regions (e.g., geographical areas), at which the natural disaster has occurred. In some examples, each ML model predicts a respective characteristic of the natural disaster. Example ML models can include, without limitation, a risk model that predicts a likelihood of occurrence of the natural disaster in a region, a spread model that predicts a rate of spread of the natural disaster in the region, a spread model that predicts a spread of the natural disaster in the region, and an intensity model that predicts an intensity of the natural disaster. Characteristics of a natural disaster can be temporal. For example, a risk of wildfire is higher during a dry season than during a rainy season. Consequently, each ML model can be temporal. That is, for example, each ML model can be trained using training data representative of regions at a particular period of time.

In some examples, the region data can include an image of the region and a set of properties of the region. More generally, the region data can be described as a set of data layers (e.g., N data layers), each data layer providing a respective type of data representative of a property of the region. In some examples, the data layers can number in the tens of data layers to hundreds of data layers. In some examples, each data layer includes an array of pixels, each pixel representing a portion of the region and having data associated therewith that is representative of the portion of the region. A pixel can represent an area (e.g., square meters (m²), square kilometers (km²)) within the region. The area that a pixel represents in one data layer can be different from the area that a pixel represents in another data layer. For example, each pixel within a first data layer can represent X km² and each pixel within a second data layer can represent Y km², where X≠Y.

An example, data layer can include an image layer, in which each pixel is associated with image data, such as red, green, blue (RGB) values (e.g., each ranging from 0 to 255). Another example layer can include a vegetation layer, in which, for each pixel, a normalized vegetation difference index (NVDI) value (e.g., in range of [−1, 1], lower values indicating absence of vegetation). Other example layers can include, without limitation, a temperature layer, in which a temperature value is assigned to each pixel, a humidity layer, in which a humidity value is assigned to each pixel, a wind layer, in which wind-related values (e.g., speed, direction) are assigned to each pixel, a barometric pressure layer, in which a barometric pressure value is assigned to each pixel, a precipitation layer, in which a precipitation value is assigned to each pixel, and an elevation layer, in which an elevation value is assigned to each pixel.

In general, data values for pixels of data layers can be obtained from various data sources including data sources provided by, for example, governmental entities, non-governmental entities, public institutions, and private enterprises. For example, data can be obtained from databases maintained by the National Weather Service (NWS), the United States Fire Service (USFS), and the California Department of Forestry and Fire Protection (CAL FIRE) among many other entities. For example, weather-related data for a region can be obtained from a web-accessible database (e.g., through a hypertext transfer protocol (HTTP), calls to an application programming interface (API)). In another example, data stored in a relational database can be retrieved through queries to the database (e.g., structured query language (SQL) queries).

In general, data values for pixels of data layers can be obtained from various data sources including data sources provided by, for example, governmental entities, non-governmental entities, public institutions, and private enterprises. For example, data can be obtained from databases maintained by the National Weather Service (NWS), the United States Fire Service (USFS), and the California Department of Forestry and Fire Protection (CAL FIRE), among many other entities. For example, weather-related data for a region can be obtained from a web-accessible database (e.g., through a hypertext transfer protocol (HTTP), calls to an application programming interface (API)). In another example, data stored in a relational database can be retrieved through queries to the database (e.g., structured query language (SQL) queries).

Because values across the data layers can change over time, the region data can be temporal. For example, temperature values for the region can be significantly different in summer as compared to winter.

Accordingly, the region data can include an array of pixels (e.g., [p_{1,1}, . . . , p_{i,j}]), in which each pixel is associated with a vector of N dimensions, N being the number of data layers. For example, p_{i,j}[I_{i,j}, V_{i,j}, W_{i,j}, . . . ], where I is image data, V is vegetation data, and W is weather data.

As training data, the region data, which can be referred to as region training data in the context of training, can include one or more characteristic layers that provides known characteristic data for respective characteristics of a natural disaster. The known characteristic data represents actual values of the respective characteristics as a result of the natural disaster. For example, a wildfire can occur within a region and, as a result, characteristics of intensity, spread, duration, and the like can be determined for the wildfire. Accordingly, as training data, the region data can include, for example, p_{i,j}=[I_{i,j}, V_{i,j}, W_{i,j}, . . . , C_{A,i,j}^{K}, C_{B,i,j}^{K}, . . . ], where C_{A,i,j}^{K} and C_{A,i,j}^{K} are respective known (K) characteristics (i.e., historical characteristics) of a natural disaster in question.

One or more ML models are trained using the region training data. The training process can depend on a type of the ML model. In general, the ML model is iteratively trained, where, during an iteration, also referred to as epoch, one or more parameters of the ML model are adjusted, and an output (e.g., predicted characteristic value) is generated based on the training data. For each iteration, a loss value is determined based on a loss function. The loss value represents a degree of accuracy of the output of the ML model as compared to a known value (e.g., known characteristic). The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value.

To generate predictions, region data representative of a region, for which predictions are to be generated, is provided as input to a (trained) ML model, which generates a predicted characteristic for each pixel within the region data. An example output of the ML model can include p_{i,j}=[C_{i,j}^{P}], where C is a characteristic predicted (P) by the ML model. Example characteristics can include, without limitation, likelihood of occurrence (e.g., risk), a rate of spread, an intensity, and a duration. In some examples, an image of the region can be displayed to visually depict the predicted characteristic across the region. For example, different values of the characteristic can be associated with respective visual cues (e.g., colors, shades of colors), and the predicted characteristic can be visually displayed as a heatmap over an image of the region.

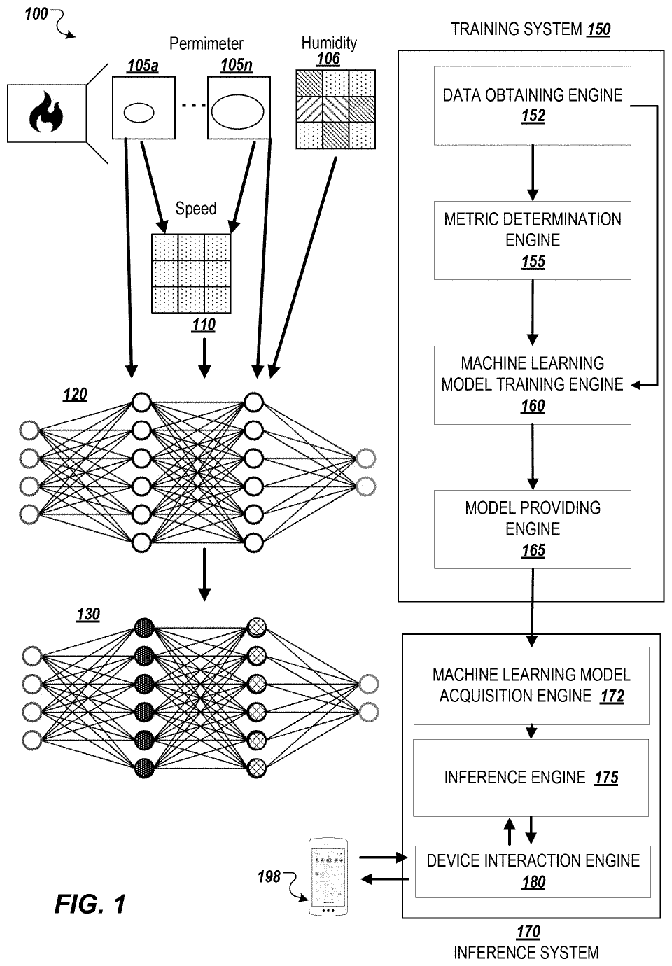

FIG. 1 is a diagram of an example fire behavior prediction system 100 for training one or more fire behavior ML models. The fire behavior prediction system 100 can include a training system 150 and an inference system 170. The training system 150 can include a data obtaining engine 152, a metric determination engine 155, a ML model training engine 160, and a ML model providing engine 165.

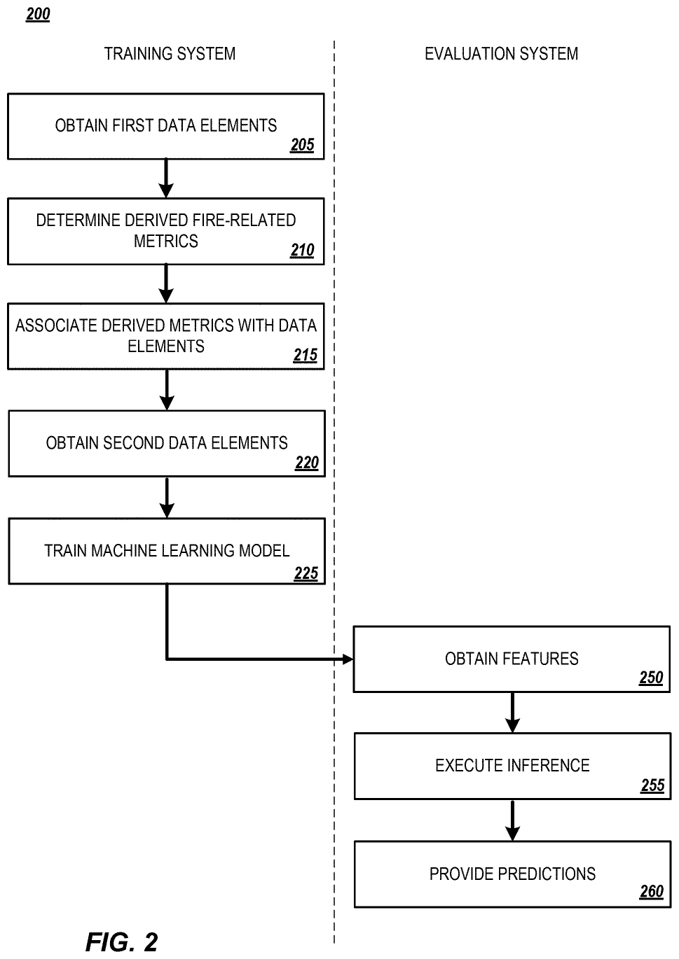

The data obtaining engine 152 can obtain data values related to a geographic area of interest, also called a “zone,” such as where a fire has previously occurred. Data values can be organized as data layers (or simply “layers”) that include data values related to the zone. Each layer can be subdivided into pixels, which can be rectangular or other geometric shapes and the size of each pixel can be the same. Each pixel in a layer can contain a data value relevant to a portion of the area of interest. For example, one data layer can include, for each pixel in the area of interest, the humidity value at the sub-region represented by the pixel 106, another data layer can include the value of a vegetation index at the sub-region represented by the pixel, and another data layer can pixels that indicate whether the sub-region was burned at a given point in time 105a-105n. Data layers are discussed further in reference to FIG. 2.

The data obtaining engine 152 can obtain data values from data sources, such as databases, using conventional data acquisition techniques such as structured query language (SQL) calls, Hypertext Transfer Protocol (HTTP), web services application programming interfaces (APIs), remote procedure calls, and so on.

The metric determination engine 155 can accept one or more data layers from the data obtaining engine 152. The metric determination engine 155 can use the data layers to determine one or more derived fire-related metrics, such as the fire speed, as described further below. The metric determination engine 155 can create one or more data layers containing derived metrics 110 and each pixel in a layer that corresponds to a burned sub-region of space can contain the same value—that is, the value of the derived metric for that layer.

The ML model training engine 160 can receive data layers 105a-105n, 106 from the data obtaining engine 152 and data layers 110 from the metric determination engine 155, and use at least some of the data layers 105a-105n, 106, 110 to train a ML model 120.

The ML model 120 can be any appropriate supervised ML model that can be configured to accept data layers representing fire metrics and produce predictions related to a fire. For example, the ML model 120 can be a gradient boosted decision tree, a random forest or a convolutional neural network. The ML model training engine 160 can produce a trained ML model 130.

The ML model providing engine 165 can provide the trained ML model 130 to the inference system 170. The training system 150 can also provide configuration information about the trained ML model 130 (e.g., weight values for nodes in a neural network) that can be used by the inference system 170 to configure a ML model. The ML model providing engine 165 can make the ML model and/or configuration information available using conventional techniques such as placing the information in a relational database, on a web server or in a file system.

The inference system 170 can include a ML model acquisition engine 172, a inference engine 175, and a device interaction engine 180.

The ML model acquisition engine 172 can accept a trained ML model 130, for example, from the training system 150. In some examples, the ML model acquisition engine 172 can accept configuration information about the trained ML model 130 (e.g., weight values for nodes in a neural network) that can be used by the ML model acquisition engine 172 to configure a ML model.

The inference engine 175 can accept a set of fire-related features and produce input from the features, which are described in further detail. In some examples, the features can be organized as data layers containing pixels, where each pixel contains a data value related to sub-region of space, as described above.

The inference engine 175 can process the input using the trained ML model that is configured to generate a fire behavior prediction output that characterizes predicted future behavior of a fire. The inference engine 175 can provide the predictions to the device interaction engine 180.

The device interaction engine 180 can provide the predictions to devices 190. For example, the device interaction engine 180 can store the predictions in an Internet-connected storage facility such as a database, a web server or a file system. The devices 190 can use conventional data retrieval techniques to retrieve the predictions. For example, the device 190 can use SQL to retrieve the prediction from a database or HTTP to retrieve the prediction from a web server. Examples of devices can include personal computers, tablets, mobile phones, servers and so on.

FIG. 2 is a flow diagram of an example process 200 for training one or more fire behavior ML models. For convenience, the process 200 for training a fire behavior ML model will be described as being performed by a system for training a fire behavior ML model, such as the system 100 for training a fire behavior machine learning model of FIG. 1, appropriately programmed to perform the process 200.

The system obtains a first set of data elements (205). In some implementations, the system can retrieve the data elements from external data sources. For example, the system can use SQL calls to retrieve data from one or more databases or calls to API provided by other data sources, for example, using Web Services. In some implementations, the system can provide an API that accepts data elements and external data sources can provide data elements by calling the API.

The data elements can be one or more layers that contain data related to a fire that occurred in the area over a specified period of time. For example, the system can obtain data layers that each contain the burn zone of a fire on a specified day. A pixel in the data layer can indicate whether the region within the zone has burned over the specified period. For example, and without limitation, the value “1” can indicate that a pixel has burned during the specified period and such a pixel can be called a “burned pixel.” In some examples, and without limitation, the value “0” can indicate that a pixel has not burned.

The system determines one or more derived fire-related metric (210). The derived fire-related metrics can be determined by analyzing the data layers, and specifically data related to a fire, and determining the derived metrics from the received metrics.

In some examples, a size of a fire can be determined by determining the area of the region covered by burned pixels by summing the size of the sub-regions corresponding to the burned pixels. If the data layer contains burned pixels from the entire fire and each pixel represents the same size region, the system can determine a number of burned pixels (e.g., pixels with a “1” value) and multiply the number of burned pixels by the size of the region to determine the area. If pixels do not represent the same size region, for each burned pixel, the system determines the size of the region corresponding to the pixel and sums those sizes.

In some implementations, a data layer will contain only the pixels that have burned since the prior data layer was captured—that is, the incremental burn regions. In such cases, the system can create an intermediate data layer by taking a union of the values in the data layers corresponding to the duration of the fire. To compute a union, the value of each pixel in the additional layer can be “1,” for example, if any of the layers contain a “1” in the corresponding pixel, and “0” otherwise. The system can compute the area from the intermediate data layer using the techniques described herein.

In some examples, a duration of the fire can be determined by subtracting a time stamp associated with the data layer corresponding to the beginning of the fire from a timestamp associated with the data layer corresponding to the end of the fire. The beginning of the fire can be indicated directly in the data, or it can be determined by the system as being the time associated with the data layer that first contains a configured number of burned pixels. The end of the fire can be indicated directly in the data, or can be determined by the system by determining the time associated with the first data layer in which the difference between the burned area in that data layer and the temporally subsequent data layer changes by less than a configured amount, which can be zero to indicate that the fire is no longer spreading.

In some examples, an expansion of a fire can be determined by comparing the areas corresponding to burned pixels of two data layers that are temporally adjacent—that is, one measuring time period Tᵢ and another measuring time period Tᵢ₊₁. The expansion of the fire can be computed as the difference in the number of burned pixels in the layer measuring time period Tᵢ₊₁ and the number of burned pixels in the layer measuring time period Tᵢ. The area of a fire can be determined as described herein.

In some examples, a speed of a fire can be determined by comparing the areas corresponding to burned pixels of two data layers and dividing by the time difference between when the data for the data layers was measured and adjusting for pixel dimensions. A technique for determining the area for a data layer is described herein, and the time difference can be computed by subtracting timestamps associated with a data layer measured earlier from the timestamp associated with a data layer measured later. Other derived metrics can also be determined by computing difference in values between data layers.

In some implementations, value categories are assigned. Value categories can be assigned by comparing values to threshold values. For example, if the speed of a fire is determined to be at least a first threshold value (e.g., 5 kilometers/hour (km/h)), a value associated with a “fast fire” category can be assigned. If the speed of a fire is determined to be between a second threshold (e.g., 1 km/h) and the first threshold (e.g., 5 km/h), a value associated with a “medium fast fire” category can be assigned. If the speed of a fire is determined to be no faster than the second threshold (e.g. 1 km/h), a value associated with a “slow fire” category can be assigned. In some implementations, both the value and the value category are used.

The system can associate derived metrics with data elements (215) in a data layer. The system can create a data layer in which the system assigns to each burned pixel the value of a derived fire-related metrics computed in 210. In some implementations, the value is used; in some implementations, the category is used; and in some implementations, multiple data layers are created using both values and categories. Each pixel that is not a burned pixel can be assigned a NULL value such as 0. Note that, in such derived data layers, the value of each burned pixel is the same (i.e., derived value and/or category) and the value of each non-burned pixel contains a NULL value. Creating one or more derived data layers, each containing derived features, enables the system to be trained to more robustly predict one or more fire behaviors. That is, the derived data layers can be regarded as supplemental training data that is added to initial training data for training a ML model.

The system can obtain a second set of data elements (220) such as terrain-related data layers, weather-related data layers, etc., as described above. In some examples, the second set of data elements can be characterized as initial training data. In some implementations, the system can retrieve the data elements from external data sources.

The system can train a ML model (225) using (i) one or more data layers that include the derived values and (ii) one or more data layers that contain values corresponding to at least a subset of the first data elements (that is, the data elements used to determine the derived value or value) and the second data elements. In some examples, as noted above, the value for each burned pixel in a derived data layer is the same, and specifically, either the derived value or the category of a derived value.

When training a ML model to predict a behavior of a fire, the derived values related to the behavior are used as labels for training labels. Such derived values indicate that, if a fire burns the region corresponding to the pixel, the region will burn according to the behavior attribute. For example, if the region represented by a pixel burns, a ML model trained on derived data relating to the speed of fire expansion will predict the speed of fire expansion at the region, among other characteristics.

In some implementations, multiple ML models are trained, where each of the multiple ML models is trained to predict a particular behavior of a fire. For example, one ML model can be trained to predict the size of a fire, another ML model can be trained to predict the speed of a fire, another ML model can be trained to predict the expansion of a fire, and another ML model can be trained to predict duration of the fire.

The training process for the ML model can depend on the type of ML model used. For example, if a ML model is a neural network, the ML model can be trained using a loss function and backpropagation.

The system can obtain features (250) to be used to generate predictions one or more fire behavior ML models that have been trained (225). Features can be fire-related metrics organized as data layers representing an area of interest. As noted above, features can include terrain-related features, weather-related features, etc. Features can be obtained from external data sources or through an API provided by the system, as described above. In implementations where the system includes multiple ML models, the system can also obtain an indication of the ML model to be used, such as a ML model that predicts whether a region, if burned, will be burned by a fast fire. Multiple ML models can also be specified.

The system can generate an input from the features. If the features are obtained in an appropriate format for the ML model (e.g., as a vector (embedding) corresponding to the input required by the ML model), the system can use the received features as input. If the features are not in an appropriate format, the system can adapt the format (e.g., by transforming the features into a vector (embedding)).

The system can process the input using one or more trained ML models (255) that are each configured to generate a fire behavior prediction output that characterizes predicted future behavior of a fire. The result of processing each ML model is an output that includes one or more data layers, and for each pixel in a data layer, the value indicating a predicted behavior of the fire at the pixel. For example, if the selected ML model predicts fire speed, an output pixel reflects the predicted speed of the fire at the pixel in the event that the area represented by the pixel burns. The system can provide the predictions (260) included in the output. For example, the system can provide the predictions to a web server where the predictions are available over HTTP.

In some implementations, the predictions can include predicted behaviors (e.g., speed, size, expansion, duration) of fires that are likely to occur within a given time period. For example, if the ML model has been trained (225) in 1-year increments, the trained ML model can be used to make predictions (255) about fires in the coming year using the historical values of features, or predicted values of the features (e.g., as produced by a weather prediction ML model).

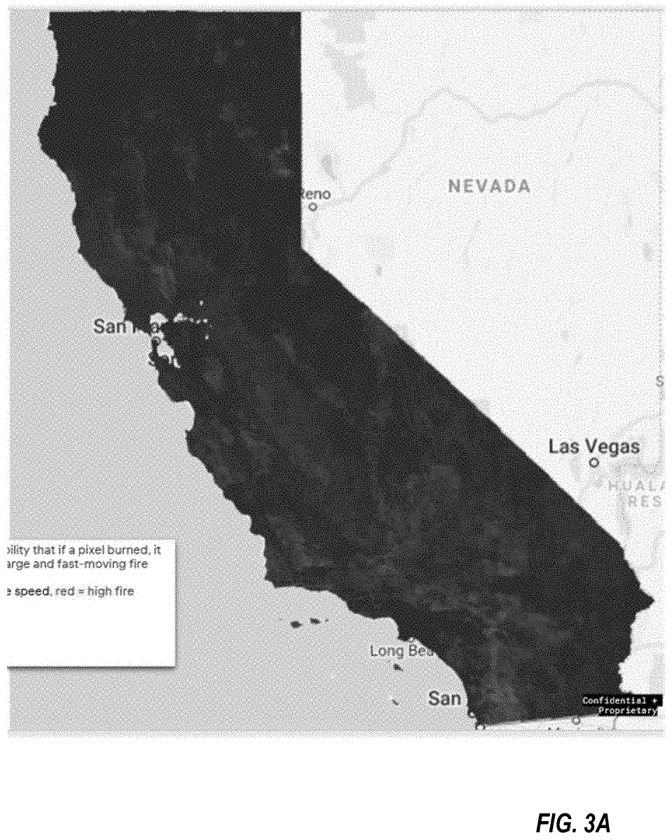

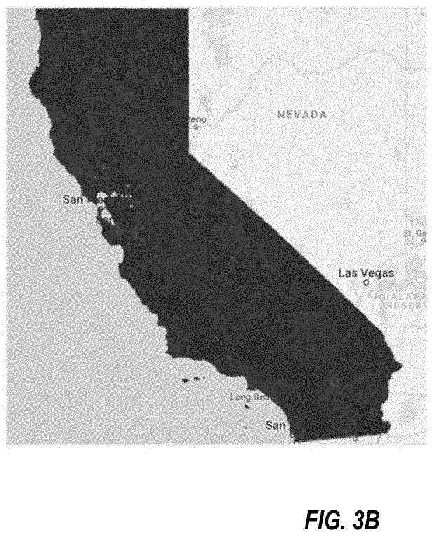

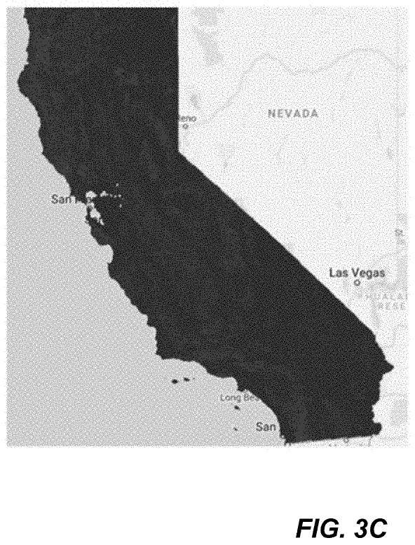

In some implementations, such predicted fire behaviors (e.g., speed, size, expansion, duration) that are likely to occur within a given time period can be illustrated on maps that show, for each pixel that burns in a fire, the predicted properties of a fire that burns the pixel. For example, FIG. 3A illustrates a predicted likelihood that a pixel will burn in a fast-moving fire (e.g., the speed of the fire exceeds a configured threshold). FIG. 3B illustrates a predicted likelihood that a pixel will burn in a large fire (e.g., the size of the fire exceeds a configured threshold). FIG. 3C illustrates a predicted likelihood that a pixel will burn in a long-lasting fire (e.g., the duration of the fire exceeds a configured threshold).

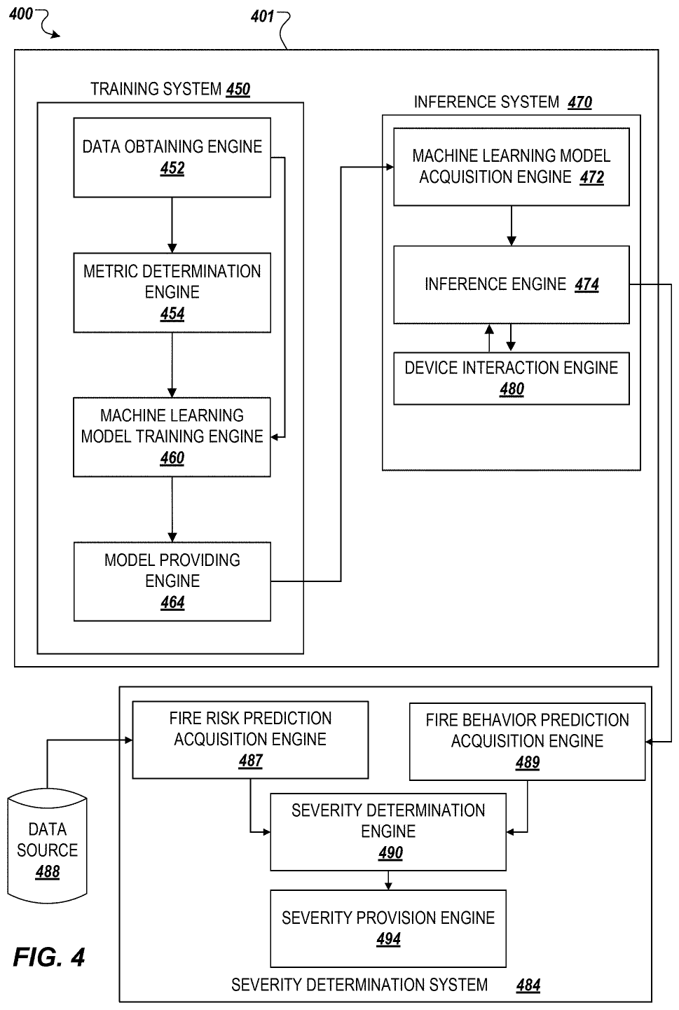

FIG. 4 is a diagram of an example system 400 for predicting fire severity. The system 400 can include a system for training one or more fire behavior ML models 401 and a severity determination system 484.

The system for training one or more fire behavior ML models 401 can be the system for training one or more fire behavior ML models 100 of FIG. 1. The training system 450 can be the training system 140 of FIG. 1. Within the training system 450, a data obtaining engine 452 can be the data obtaining engine 142 of FIG. 1; a metric determination engine 454 can be the metric determination engine 145 of FIG. 1; a ML model training engine 460 can be the ML model training engine 160 of FIG. 1; and a ML model providing engine 464 can be the ML model providing engine 164 of FIG. 1. An inference system 470 can be the inference system 170 of FIG. 1. Within the inference system 470, a ML model acquisition engine 474 can be the ML model acquisition engine 174 of FIG. 1; an inference engine 474 can be the inference engine 174 of FIG. 1; and a device interaction engine 480 can be the device interaction engine 180 of FIG. 1.

The severity determination system 484 can include a fire risk prediction acquisition engine 487, a fire behavior prediction acquisition engine 489, a severity determination engine 490, and a severity provision engine 494. The fire risk prediction acquisition engine 487 can accept fire risk predictions relevant to a zone of interest and for a particular time period (e.g., a calendar year such as 2022). The fire risk prediction acquisition engine 487 can obtain the fire risk predictions from a data source 488, or from multiple data sources, configured to provide fire risk predictions. A fire risk prediction can be organized as a data layer (as described above) where each pixel in the layer indicates the predicted likelihood that a fire will occur at the region represented by the pixel during a configured time period.

The fire behavior prediction acquisition engine 489 can obtain fire behavior predictions, for example, from the system for training one or more fire behavior ML models 401. Fire behavior predictions can be organized as data layers (as described above) where each pixel in a layer indicates a predicted fire behavior at the region represented by the pixel.

As further noted above, fire behaviors can include size, speed, duration, expansion, and the like. In some implementations, fire behavior predictions can include a category (e.g., “fast fire”). In such implementations, a value associated with each pixel can indicate the likelihood that a fire in the category will occur if a fire ignites at the region represented by the pixel. The likelihood can be a probability (e.g., a real number in the range 0 to 1, inclusive).

A severity determination engine 490 can accept fire risk predictions from the fire risk prediction acquisition engine 487 and fire behavior predictions from the fire behavior prediction acquisition engine 489 and provide a severity prediction to the severity provision engine 494. A severity prediction can be represented as a data layer where the value associated with each pixel can indicate the likelihood that a fire exhibiting a particular behavior will within a configured time period. The likelihood can be a probability (e.g., a real number in the range 0 to 1, inclusive).

The severity provision engine 494 can make severity predictions available to devices coupled to the severity determination system 484. For example, the severity provision engine 494 can provide an API that allows devices to request severity predictions and can respond to request made through that API with one or more severity predictions. The API can be implemented as a web service, a remote procedure call, an SQL query, etc.

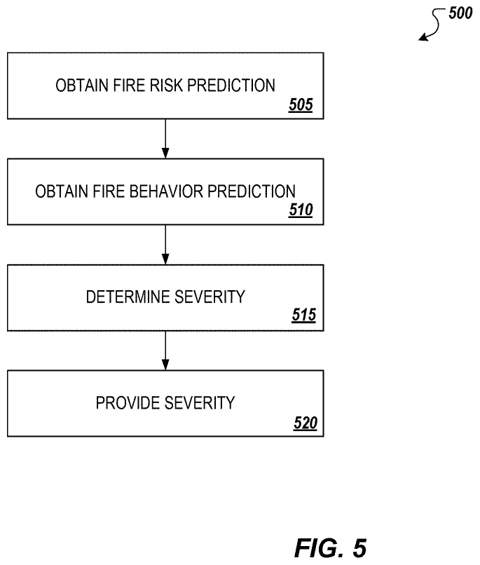

FIG. 5 is a flow diagram of an example process for predicting fire severity. For convenience, the process 500 for predicting fire severity will be described as being performed by a system for predicting fire severity (e.g., the system 400 for predicting fire severity of FIG. 4, appropriately programmed to perform the process 500).

The system obtains a fire risk prediction (505). The system can obtain fire risk predictions from any suitable fire risk prediction data provider. For example, the United State Fire Service and the California Department of Forestry and Fire Protection provide fire risk predictions. The system can obtain fire risk predictions by accessing an API provided by the fire risk prediction data provider or by using a network protocol such as HTTP or File Transfer Protocol (FTP) to retrieve the fire risk predictions. In some implementations, the system can subscribe to fire risk predictions, and the fire risk prediction data provider can “push” fire risk predictions to the system, for example, by utilizing an API provided by the system.

The system obtains one or more fire behavior predictions (510). In some implementations, the system obtains fire behavior predictions by performing the process 300 described in reference to FIG. 3. In some implementations, the system can obtain fire behavior predictions, for example, by accessing predictions through the device interaction engine 180 of FIG. 1.

The system determines severity (515) by combining the fire risk prediction and the fire behavior prediction. For example, if the fire behavior prediction represents predictions relating to a fast fire, the determined severity represents, at each pixel, the probability of a fast fire occurring. In some implementations, the fire risk predictions and the fire behavior predictions are both expressed as probabilities (e.g., real numbers in the range to 1, inclusive) for each pixel in a zone. In such cases, the severity prediction can be determined as the product of the probability value at a pixel in the fire risk prediction representing a region and the probability value at a pixel in the fire behavior prediction representing the same region.

The system can also determine more complex severity measures by including multiple behavior prediction. The severity prediction can be determined as the product of the probability value at a pixel in the fire risk prediction representing a region and the probability value at each pixel in each fire behavior prediction representing the same region. For example, the system can determine the probability of a at risk of a large and fast fire within a certain time frame at a region by determining the product of the values in the pixels representing the same region in a “fast fire” prediction, a “large fire” prediction and the fire risk prediction, where “fast fire” and “large” fire are categories, as discussed previously.

The system can provide the severity (520) by making the data layers containing one or more severity prediction available to computing devices connected to the system. For example, the system can: (i) place the predictions on a web server where the predictions are available to computing devices that access the corresponding Uniform Resource Locator (URL); (ii) store the predictions in a relational database where the predictions are available to computing devices via SQL calls; or (iii) place the predictions on a file system where the predictions are available to computing devices that use convention file system APIs.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing ML models can also include, for example, special-purpose hardware accelerator units for processing common and compute-intensive parts of machine learning training or production (i.e., inference, workloads).

ML models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
obtaining a first plurality of data elements, each data element representing a fire-related metric of a geographic region;
determining, using at least a subset of the first data elements, one or more values representing one or more derived fire-related metrics;
associating the one or more values with the first plurality of data elements;
obtaining a second plurality of data elements, each data element representing a fire-related metric of the geographic region; and
training a machine learning (ML) model using at least a subset of the first plurality of data elements, at least a subset of the second plurality of data elements, and the values associated with the subset of the first plurality of data elements to provide a trained ML model.

2. The computer-implemented method of claim 1, further comprising:
generating an input from at least the subset of the first plurality data elements, at least the subset of the second plurality of data elements and the one or more values; and
processing the input using the trained ML model that is configured to generate a fire risk prediction output that characterizes predicted future behaviors of a fire.

3. The computer-implemented method of claim 1, wherein the geographic region is contiguous.

4. The computer-implemented method of claim 1, wherein at least one fire-related metric is related to one of terrain and weather.

5. The computer-implemented method of claim 1, wherein the derived fire-related metrics comprise one or more of speed, size, duration, and expansion.

6. The computer-implemented method of claim 1, wherein the ML model comprises one of a gradient boosted decision tree, a random forest, and a convolutional neural network.

7. A non-transitory computer-readable storage medium coupled to one or more processors and having instructions stored thereon which, when executed by the one or more processors, cause the one or more processors to perform operations comprising:
obtaining a first plurality of data elements, each data element representing a fire-related metric of a geographic region;
determining, using at least a subset of the first data elements, one or more values representing one or more derived fire-related metrics;
associating the one or more values with the first plurality of data elements;
obtaining a second plurality of data elements, each data element representing a fire-related metric of the geographic region; and
training a machine learning (ML) model using at least a subset of the first plurality of data elements, at least a subset of the second plurality of data elements, and the values associated with the subset of the first plurality of data elements to provide a trained ML model.

8. The non-transitory computer-readable storage medium of claim 7, wherein operations further comprise:
generating an input from at least the subset of the first plurality data elements, at least the subset of the second plurality of data elements and the one or more values; and
processing the input using the trained ML model that is configured to generate a fire risk prediction output that characterizes predicted future behaviors of a fire.

9. The non-transitory computer-readable storage medium of claim 7, wherein the geographic region is contiguous.

10. The non-transitory computer-readable storage medium of claim 7, wherein at least one fire-related metric is related to one of terrain and weather.

11. The non-transitory computer-readable storage medium of claim 7, wherein the derived fire-related metrics comprise one or more of speed, size, duration, and expansion.

12. The non-transitory computer-readable storage medium of claim 7, wherein the ML model comprises one of a gradient boosted decision tree, a random forest, and a convolutional neural network.

13. A system, comprising:
a computing device; and
a computer-readable storage device coupled to the computing device and having instructions stored thereon which, when executed by the computing device, cause the computing device to perform operations comprising:
obtaining a first plurality of data elements, each data element representing a fire-related metric of a geographic region;
determining, using at least a subset of the first data elements, one or more values representing one or more derived fire-related metrics;
associating the one or more values with the first plurality of data elements;
obtaining a second plurality of data elements, each data element representing a fire-related metric of the geographic region; and
training a machine learning (ML) model using at least a subset of the first plurality of data elements, at least a subset of the second plurality of data elements, and the values associated with the subset of the first plurality of data elements to provide a trained ML model.

14. The system of claim 13, wherein operations further comprise:
generating an input from at least the subset of the first plurality data elements, at least the subset of the second plurality of data elements and the one or more values; and
processing the input using the trained ML model that is configured to generate a fire risk prediction output that characterizes predicted future behaviors of a fire.

15. The system of claim 13, wherein the geographic region is contiguous.

16. The system of claim 13, wherein at least one fire-related metric is related to one of terrain and weather.

17. The system of claim 13, wherein the derived fire-related metrics comprise one or more of speed, size, duration, and expansion.

18. The system of claim 13, wherein the ML model comprises one of a gradient boosted decision tree, a random forest, and a convolutional neural network.
